(19) United States
(12) Patent Application Publication
(10) Pub. No.: US 2026/0355685 A1
(43) Pub. Date: Nov. 12, 2026

(54) AN AIR CONDITIONING SYSTEM AND AN INSTALLATION THAT COMBINES SAID SYSTEM WITH A DRYING, GRANULATING OR COATING DEVICE IN THE FIELD OF PHARMACEUTICAL PRODUCT MANUFACTURING

(71) Applicant: ROMACO TECPHARM, S.L., RUBI, Barcelona (ES)

(72) Inventors: Pedro CUADRADO FERNÁNDEZ, BARCELONA (ES); Cristina BENÍTEZ FLORES, ALAQUÀS (ES); Albert GARCIA I GARCIA, MOLINS DE REI (ES)

(73) Assignee: ROMACO TECPHARM, S.L., RUBI, Barcelona (ES)

(21) Appl. No.: 19/475,235

(22) PCT Filed: Apr. 4, 2024
(86) PCT No.: PCT/ES2024/070209

§ 371 Date: Oct. 14, 2025

(30) Foreign Application Priority Data
Apr. 14, 2023 (ES) U202330620

(51) Int. Cl. B01D 53/26; A61J 3/00

(52) U.S. Cl. CPC B01D 53/265; A61J 3/005; A61J 2200/42; B01D 2257/80

(57) ABSTRACT

An air conditioning system used in a drying, granulating or coating process in pharmaceutical product manufacturing, including a conveying mechanism for conveying the air in which is being conditioned divided into a first unit, which houses a dehumidification mechanism, and a second unit, which houses the heating mechanism for the dehumidified air, the first and second units prepared to be coupled in series and provide continuity to the air conveyance. The air conveyance mechanism includes a third unit that can be coupled between the first and the second units giving continuity to the air conveyance with a heat recovery unit of the indirect contact gas-gas type through which the air being conditioned is forced to circulate for preheating thereof, the third unit provided for this purpose with a hot inlet and a cold outlet for the recovery gas that is also forced to circulate through the heat recovery unit.

### TECHNICAL FIELD OF THE INVENTION

The invention relates to an air conditioning system to be used in a drying, granulating or coating process in the field of pharmaceutical product manufacturing. The invention also relates to an installation that combines this air conditioning system with a drying, granulating or coating device that uses the conditioned air by means of the system for the operation thereof.

### BACKGROUND OF THE INVENTION

The use of air conditioning systems is known in pharmaceutical product manufacturing processes that use, or require, a flow of clean air that also meets certain humidity and temperature conditions. This air can be used, for example, to dry tablets freshly coated with liquid substances or to ensure uniform contact of granular products with liquid coating substances in fluidised beds.

A typical example of a coating device that requires the supply of a dry air flow and a target temperature for the operation thereof is described in patent document U.S. Pat. No. 6,511,541.

Although the technical principle applied by these coating devices has not changed substantially for several years, it is true that they have been perfected in order to increase their operating efficiency.

Thus, for example, when these coating devices were previously sized to work with batches of a specific size of articles to be coated, these devices now share the market with coating devices prepared to be able to work with batches of various sizes. In this sense, patent document EP3597048 discloses a coating device capable of orienting and arranging a group of sprayers in an ideal position inside a perforated rotating drum, through which passes a flow of conditioned air, in which the articles to be coated are confined and stirred, being able to select the ideal position of the sprayers according to the batch size of articles confined in the drum; and patent document EP3903922 discloses a coating device prepared to adjust and concentrate the outlet of the conditioned air that passes through the drum, coinciding with the part of the drum that is covered by the batch of articles confined in the drum.

This improvement in efficiency does not necessarily translate, or translates to a lesser extent than desirable, into energy savings.

A first objective of the invention is an air conditioning system that, in combination with a device that uses or requires air conditioning by means of the system for the operation thereof, results in energy savings.

Objectives of the invention also include offering a solution that is constructively versatile, that is, one that can be easily adapted to the specific requirements of each installation that needs an air conditioning system and that allows, for example, manufacturing and delivery times of the equipment to be reduced.

Furthermore, installations that incorporate devices of the type that use or require air conditioning flows produce used air, which is dirty due to having been in contact with liquid substances that contain active pharmaceutical ingredients, which must be treated to clean the same before being expelled outside. In addition to the regulations or standards applicable to the cleaning of this dirty air, there may be other regulations or standards that are commonly applicable to industrial installations that must be complied with, one of them being that which deals with noise. It is common for the aforementioned installations, which have drying, granulating or coating devices, to have to incorporate silencing or attenuating devices of the noise that can be made by the used air being expelled to the outside, after being cleaned.

### DESCRIPTION OF THE INVENTION

The proposed system is especially suitable for air conditioning to be used in a drying, granulating or coating process in the field of pharmaceutical product manufacturing.

The system comprises conveying means for conveying the air being conditioned through dehumidification means and heating means for the dehumidified air and is essentially characterised in that the conveying means are divided into a first air conveying unit or module, which houses the dehumidification means; and a second air conveying unit or module, which houses the heating means for the dehumidified air, the first and second units being prepared to be coupled in series and providing continuity to the air conveyance.

The air conveying means of the system according to the invention are complemented by a third air conveying unit or module, which can be coupled between the first and the second units and can provide continuity to the air conveyance through the first, the third and the second units, in this order, said third unit comprising a heat recovery unit of the indirect contact gas-gas type through which the air being conditioned is forced to circulate for preheating thereof, the third unit being provided for this purpose with a hot inlet and a cold outlet for the recovery gas that is also forced to circulate through the heat recovery unit.

As explained in more detail below, this partition allows a particularly advantageous modular construction of the system adopting at least two different configurations: with and without the third unit.

As explained later, the system is designed so that the recovery gas is a flow of used air that comes from the air conditioning flow itself by means of the system of the invention after being used in a device that requires, for its operation, an air flow at certain target conditions.

In a non-deducible way, the interposition of the third unit between the first and the second units not only allows the air being conditioned to be preheated before being heated in the second unit but can also replace, or moreover, avoid the need to equip an installation, with a silencing or attenuating device of the noise of expelling a used air flow. That is, the heat recovery unit can deploy a noise suppression effect on the expulsion of a used gas if this is precisely the gas that is used as the recovery gas.

In a variant of the invention, the heat recovery unit is a hexagonal cross-flow heat exchanger.

In a variant of the invention, the first, third and second air conveying units can be coupled in succession and on the same mounting plane. Preferably, the mounting plane is a vertical plane or a horizontal plane and advantage can be taken of selecting parallelepiped shapes for the first, second and third units, facilitating the coupling and optimising the spatial arrangement thereof.

In a variant, the space surrounding the heat recovery unit in the third unit is compartmentalised alternating around the heat recovery unit and in the mounting plane a compartment in communication with an intake of air to be preheated of the heat recovery unit, into which compartment leads an inlet of air to be preheated from the third module connectable to a dehumidified air outlet of the first module when said first and third modules are mutually coupled; a preheated air compartment in communication with a preheated air expulsion of the heat recovery unit, into which compartment leads a preheated air outlet of the third module connectable to a preheated air inlet of the second module when said second and third modules are mutually coupled; a compartment in communication with an intake of air to be preheated of the heat recovery unit into which leads a hot air inlet of the third module; and a compartment in communication with a cold recovery gas expulsion of the heat recovery unit that leads into a cold outlet of the third unit.

When the mounting plane is a vertical plane, preferably the air inlet of air to be preheated is formed in the third unit to be located at a level above the preheated air outlet; and the hot recovery gas inlet is formed to be located at a level above the cold recovery gas outlet.

Among other advantages, this allows the compartment in communication with the cold recovery gas expulsion of the heat recovery unit to house an auxiliary condensate collector, located in the vertical projection of said cold recovery gas expulsion of the heat recovery unit.

When the mounting plane is a vertical plane, the system is envisioned to comprise an evacuation box of the recovery gas that can be coupled to the cold recovery gas outlet of the third unit and sized, at least in width, in accordance with the first unit, serving as a support for the said first unit.

When the mounting plane is a horizontal plane, the system is envisioned to comprise an evacuation box of the recovery gas that can be coupled to the cold recovery gas outlet of the third unit and configured to then be juxtaposed to the first unit.

In a variant, the dehumidification means housed in the first unit comprise first filter means, a cooling coil and a condensate collector.

In a variant, the heating means comprise a impelling fan, a steam coil and second filter means.

According to another aspect of interest, an installation is disclosed that combines an air conditioning system according to the present invention with a coating, spraying or drying device to which an operational air flow is supplied and a used air flow is returned, in which this operational air flow contains air conditioned by the system and in which the recovery gas used by the system contains used air.

The invention takes special advantage of the devices that do not have, or have limited, capacity to regulate the air flow to be used and that do not use all the conditioned air for their operation, this unused air losing little calorific value.

Thus, in a variant of the installation it comprises a bypass branch at the inlet of the device and the recovery gas used by the conditioning system comes from a mixture containing air used by the device and air bypassed by the bypass branch, not used by the device.

### BRIEF DESCRIPTION OF THE DRAWINGS

FIG. 1 schematically shows an air conditioning system according to a variant of the invention, in side elevation;

FIG. 2 shows an air conditioning system according to another variant of the invention, in this case in a plan view;

FIG. 3 shows an installation that combines an air conditioning system, according to the variant illustrated in FIG. 1, with a coating device;

FIG. 4 shows another installation that combines an air conditioning system, according to the variant illustrated in FIG. 1, with a drying device.

### DETAILED DESCRIPTION OF THE INVENTION

FIG. 1 shows an air conditioning system 1 according to a variant of the invention.

The system 1 comprises a first air conveying unit 10; a second air conveying unit 20; and a third air conveying unit 30.

The units 10, 30 and 20 can be coupled and in FIG. 1 they are coupled in succession, such that they form a passage for an air to be conditioned that will pass through these units, entering through an intake access 10a of the first unit 10 and leaving through an expulsion access 20b of the second unit 20 with connection means for connecting to an air duct of an installation, this air to be conditioned having passed through the third unit 30.

In the example, the first, second and third units 10, 20 and 30, respectively, have an essentially parallelepiped shape and form types of pieces of a modular system in which the first and second units 10 and 20 can be coupled in succession without interposition of the third unit 30; or alternatively the first unit 10, the third unit 30 and the second unit 20 can be coupled in succession.

The first unit 10 is prepared to dehumidify the air that passes therethrough, for which purpose it houses dehumidification means 11. In the example, the main components of these dehumidification means 11 are first filter means 12, which comprise an assembly of a first G4 filter for coarse dust and a second F9 filter for fine dust according to European standard EN 779; a cooling coil 13, sized to cool the air being conditioned to the dew point, which causes its loss of humidity; and a condensate collector 14, in the form of a condensate tray, which collects the water that precipitates from the air being conditioned after cooling.

A cooling coil is understood as any means that produces a heat exchange between the air being conditioned and a cold means, sufficient to dehumidify the air which is being conditioning at the working pressure.

The third unit 30 is prepared to preheat the air that passes therethrough, for which it houses a heat recovery 31 of the indirect contact gas-gas type through which the air being conditioned and a recovery gas are forced to circulate.

In the example, the heat recovery unit 31 is a plate and cross-flow heat exchanger. The heat transfer is carried out through the multiple layers that are housed inside the heat recovery unit 31 and arranged in such a way that the fluids, in this case the air being conditioned and the recovery gas, do not come into direct contact, since their respective circuits are completely independent. To this end, the third unit 30 comprises a hot inlet 30c for the recovery gas that mounts connection means to a recovery gas duct and that leads into a compartment of the third unit 30, compartment in communication with an intake of the heat recovery unit 31; and a cold outlet 30d of cold recovery gas into which leads another compartment of the third unit 30, a compartment in communication with a recovery gas expulsion of the heat recovery unit 31.

Naturally, other candidates for the heat recovery unit 31 are possible.

As for the second unit 20, it is prepared to heat the air already dehumidified by the first unit 10 and preheated by the third unit 30, which passes therethrough, for which it houses heating means 21. In the example, the main components of these heating means 21 are a impelling fan 22, which impel or forces the air to travel through the system 1; a steam coil, sized to heat the preheated air in the third unit 30 to a target temperature, necessary to carry out a process that will use the air conditioning, as will be explained in more detail below; and second filter means 24, comprising an absolute HEPA H13 filter according to European standard EN 779.

A steam coil is understood as any means that produces a heat exchange between a gas, preferably steam, and the air in which is being conditioned.

In the example of FIG. 1, the air conditioning system 1 has a configuration in which the first unit 10, the second unit 20 and the third unit 30 are coupled in the same vertical mounting plane.

In the aforementioned example, the third unit 30 has a height dimension similar to the sum of the first and second units 10 and 20 and the hot inlet 30c and the cold outlet 30d of the recovery gas are located diagonally opposite, the hot inlet 30c being at a higher level and the cold outlet 30d at a lower level.

The first unit 10 and the third unit 30 are prepared for their mutual coupling to give continuity to the conveyance of the air being conditioned throughout the system 1, in this case they are sized and/or prepared such that a dehumidified air outlet 10b of the first module 10 connects to an inlet of air to be preheated 30a of the third module 30 that leads to a compartment in communication with an intake of air to be preheated of the heat recovery unit 31.

Similarly, the second unit 20 and the third unit 30 are also prepared for the mutual coupling thereof to give continuity to the conveyance of the air which is being conditioned throughout the system 1, in this case they are sized and/or prepared such that a preheated air outlet 30b of the third module 30, which leads into a compartment in communication with a preheated gas expulsion of the heat recovery 31, connects with a preheated air inlet 20a of the second module 20.

Note that the example in FIG. 1 the inlet of air to be preheated 30a and the preheated air outlet 30b are located diagonally opposite, the inlet of air to be preheated 30a being at a higher level and the preheated air outlet 30b at a lower level.

Likewise, the third unit 30 comprises, in the example, respective separating partitions 32 and 33 to compartmentalise the space and prevent the mixing of the air being conditioned and the recovery gas in the containment space of the heat recovery unit 31.

Nonetheless, with the system adopting the arrangement shown in the aforementioned FIG. 1, an air conditioning circuit is formed in which the flow of air to be conditioned circulates, from left to right according to the orientation of the drawing, throughout the first unit 10 following an essentially horizontal direction, it circulates through the third unit 30, passing through the heat recovery unit 31, following a direction with a descending component and circulating along the second unit 20 following an essentially horizontal direction until leaving the second unit 20. In this system 1, the recovery gas will circulate through the third unit 30, passing through the heat recovery unit 31, following a substantially normal direction with respect to the direction that the air in which is being conditioned follows through this same third unit 30.

This particular arrangement is advantageous, for example, to locate an auxiliary condensate collector 34 at the lower level of the third unit 30, specifically in the compartment where the cold recovery gas expulsion of the heat recovery unit 31 is located. In the example, this auxiliary collector 34 is placed in the vertical projection of said cold recovery gas expulsion.

The inclination to which the heat recovery unit 31 is solidly attached in the third unit 30 favours the discharge by gravity of this recovery gas condensate.

In the example of FIG. 1, the system 1 comprises an evacuation box 40 of the recovery gas. This evacuation box 40 and the third unit 30 are also prepared for the mutual coupling thereof to give continuity to the conveyance of the recovery gas through the system 1, in this case they are sized and/or prepared such that the cold outlet 30d of the gas cold recovery gas of the third module 30 connects to a cooled recovery gas inlet 40a of the evacuation box 40.

The recovery box 40 is particularly sized in accordance with the first unit 10, at least in width, serving as a support for the same.

The evacuation box 40 comprises a recovery air outlet 40b of the system 1 that mounts connection means to a cold gas duct of the installation.

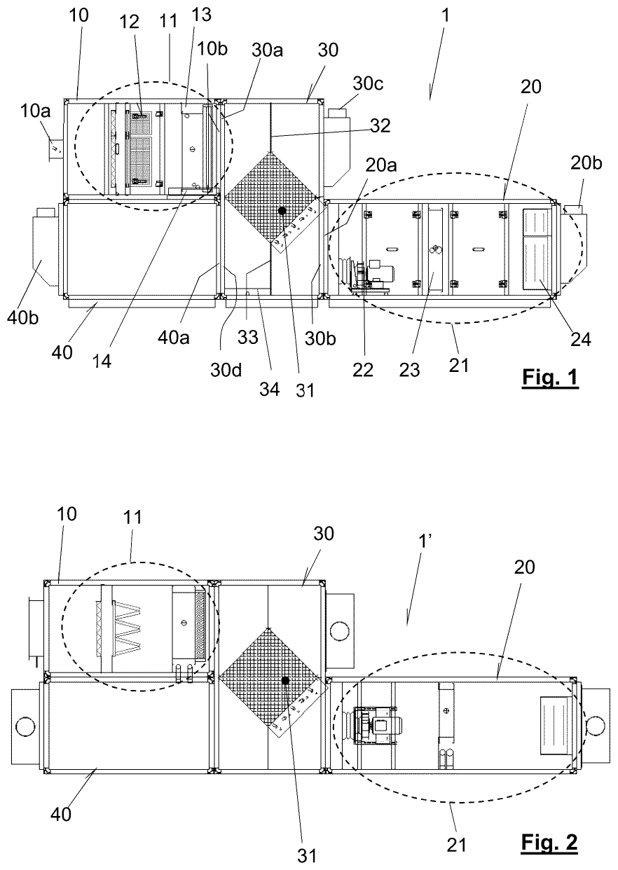

FIG. 2 shows an air conditioning system 1′ according to another variant of the invention, similar to the system 1 of FIG. 1 except that the first, the third and the second air conveying units 10, 30 and 20, respectively, are successively coupled on the same mounting plane that is now horizontal.

In the system 1′ of FIG. 2 the same numerical references have been used as in FIG. 1 to designate equivalent components, having indicated only the main components and/or means.

With the system 1′ adopting the arrangement shown in FIG. 2, an air conditioning circuit is formed in which the flow of air to be conditioned circulates, from left to right according to the orientation of the drawing, throughout the first unit 10 following an essentially horizontal direction, it circulates through the third unit 30, passing through the heat recovery unit 31, following an essentially horizontal direction but at an angle with respect to the direction that the air being conditioned followed throughout the first unit 10, and circulates through the second unit 20 following an essentially horizontal parallel with respect to the direction that the air being conditioned followed throughout the first unit 10. In this system, the recovery gas circulates through the third unit 30, passing through the heat recovery unit 31, following a substantially normal direction with respect to the direction that the air in which is being conditioned follows through this same third unit 30.

FIG. 3 illustrates an installation 100 that combines an air conditioning system according to the invention, in this case a system 1 according to FIG. 1, with a coating device 101.

The coating device 101 is of the type comprising a container within which a drum containing a production batch of the articles to be coated is rotated. To this end, the device is equipped with spraying means for spraying the product to be used to coat said articles. This spraying operation is performed while the drum rotates and stirs the batch of articles to ensure a homogeneous coating in all the articles. As is also known, the drum is perforated and the coating device comprises a circuit of forced gas, which passes through the drum helping the sprayed product to dry once applied on the articles to be coated.

A particular feature of this installation 100 is that the forced gas used in the coating device 101 is the air conditioned by the system 1; and that the recovery gas used by the system 1 is the air resulting from operating the coating device 101.

The installation 100 is exemplified based on capturing air from the outside that is fed to the system 1 through the intake access 10a of the first unit 10, air that is assumed to be at about 10° C. and with a certain humidity, in this case, 90% RH (the person skilled in the art will understand that these conditions will depend in each case on the atmospheric conditions), the system 1 being configured for the conditioning of this captured air so that it meets specific conditions of clean, dry air and at a target temperature that for the exemplary case is selected as 65° C., which are optimal conditions for the use thereof in the device 101 of the installation 100.

In support of FIG. 3, this air captured from the outside passes through the dehumidification means 11, in this case and in this order the coarse dust filter, the fine dust filter and the cooling coil, dehumidified air being obtained at the outlet of the first unit 10 from which approximately 98% of its impurities have been extracted and which will have a temperature of approximately 7-9° C., when the target temperature is 65° C. (which means a thermal leap of 58° C.).

To condition the air and raise its temperature to the target 65° C., the installation 100 takes advantage of the residual heat of the air resulting from operating the coating device 101 and the system 1 heats the air in which is being conditioned in two stages: in the first, which is carried out in the third unit 30 of the system 1, by transferring heat from the used air resulting from operating the coating device 101; and in the second, which is carried out in the second unit 20 of the system 1, by using the heating means 21 referred to above.

In the installation 100, the coating device 101 is also of the type capable of optimising its operation according to the size of the batch of articles to be coated. For this purpose, the coating device 101 may incorporate technology to arrange and orient the product ejectors of product to be sprayed at an optimal distance from the free surface of the articles in the drum and/or to regulate and concentrate the outlet of the drying air that passes through the drum coinciding with the wall thereof covered by the articles. Technological proposals in this sense are disclosed in patent documents EP3597048 and EP3903922 respectively.

This ability to regulate the operating parameters of the coating device 101 depending on the size of the batch of articles to be coated arouses interest in also being able to select the flow rate of air that must pass through the drum.

However, with the range of variability of this batch size of articles for which the coating device 101 is capable of being parameterised being from 10% to 100% of the possible load, it may be the case that the air flow variability that corresponds to each batch size cannot be assumed by the frequency converters or, ultimately, by the air impelling equipment. In this regard, it is of interest that the installation 100 proposes equipping the same with a bypass branch 102 and with associated valve means 102a to divert, from the flow of conditioned air that is conveyed to the coating device 101 through the air conditioning duct 105, the flow rate of excess air that should not be fed to the coating device 101, especially when operating with small batch sizes. This flow of excess air comes from the system 1 and is, therefore, a flow of clean air that will retain its temperature to a greater extent compared to the flow of air that passes through the drum of the device 101 and that is used in the coating process.

In the installation 100, the used air returned by the device 101, which is dirty, humid air (conditions of 80% RH can be estimated) and which will have a temperature of approximately 40-45° C., is mixed with the bypassed conditioned air. For this purpose, the installation comprises a used air duct 103 that connects the outlet of the coating device 101 to a mixer 104, downstream of the valve means 102a.

Although the temperature of the dirty air may vary depending on the type of device and the needs of the installation, the estimation of 40-45° C. indicated above will serve to exemplify the invention.

In the example installation 100, the mixture of bypassed conditioned air and used air is introduced through an interconnecting duct 109 to a dust collector 106, where the mixture is cleaned of impurities from the coating device 101. The dust collector 106 may be equipped, for example, with F9 and H13 filters.

impelling means 107 will impel the clean air, which will now perform the function of recovery gas, through a recovery gas duct 108 to the hot inlet 30c of the third unit 30 of the air conditioning system 1.

The intervention of the heat recovery unit 31 in the third unit 30 will make it possible to transfer heat from the used air, in humid conditions and at a temperature of 40-45° C., or higher depending on the bypass air ratio, to the dehumidified air that serves the first unit 10, the latter preheating before being introduced into the second unit 20.

In this case, the heat recovery unit 31 is adapted to the characteristics of the recovery gas used. For example, it is the type constructed with exchange plates attached with epoxy resin to avoid oxidation with the moisture load of the recovery gas.

Practice has made it possible to experience increases in temperature of the dehumidified air that will go from 7° C. (at the inlet of the third unit 30) to approximately 39° C. (at the outlet of the third unit 30). Consequently, the thermal leap that the heating means 21 of the second unit must provide when the target temperature is 65° C. will be only 26° C. (when this leap was 58° C. in the absence of the third unit 30) with the consequent energy savings that this entails.

Practice has shown fuel reductions, for example from using diesel fuelled steam boilers to operate the steam coil of the air conditioning system, of approximately 50% when the coating device 101 works with small batch sizes and approximately 45% (at a rate of steam savings that can be of the order of 55%) when the coating device 101 works at maximum load.

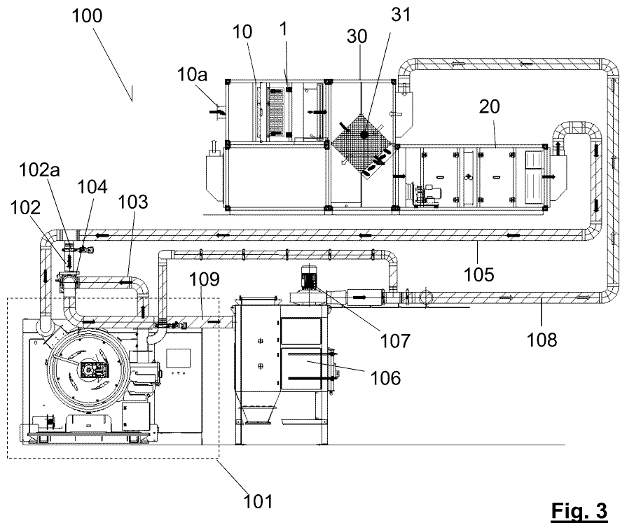

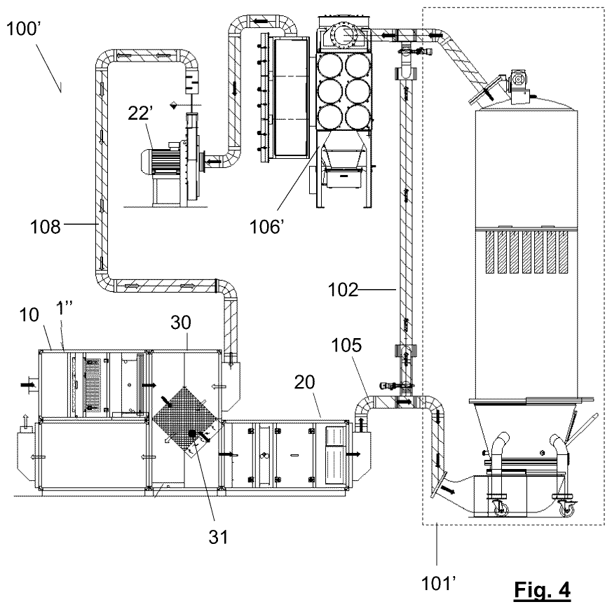

FIG. 4 illustrates an installation 100′ that combines an air conditioning system according to the invention, in this case a system 1″ very similar to that of FIG. 1, with a device 101′ which in this case is a fluidised bed drying device.

The system 1″ lacks impelling means for the air being conditioned and the air flow used by the installation is impelled by suction carried out by a centrifugal fan 22′ which is downstream of the device 101′.

The air conditioned by the system 1″ and supplied to the device 101′ will have similar conditions to the air that was supplied to the device 1 in the installation of FIG. 3. In the drying device 101′, the air is responsible for drying a granulated product in suspension with a liquid substance (or even, if required, for ensuring its correct granulation).

As in the installation 100,′ the used air in the installation 100 can be mixed at the outlet of the device 101′ with bypass air and in this case the mixture is passed through a dust collector 106′ that has fine dust and H13 absolute filters, where the mixture is completely cleaned. The resulting humid and hot air will perform the function of recovery gas in the system 1″ to preheat the dehumidified air produced by the first unit 10, through the heat recovery unit 31 in the third unit 30, before being heated in the second unit 20, all in an analogous manner to what occurred in the installation 100 of FIG. 3.

1. An air conditioning system in a drying, granulating or coating process in the field of pharmaceutical product manufacturing, the air conditioning system comprising conveying means for conveying the air is being conditioned through dehumidification means and heating means wherein
the conveying means are divided into a first unit or air conveying module, which houses the dehumidification means, and a second unit or air conveying module, which houses the heating means, the first and second units (10, 20) being configured to be coupled in series and provide continuity to the air conveyance;
the air conveying means further comprising a third unit or air conveying module, which is configured to be coupled between the first and the second units providing continuity to the air conveyance through the first, the third and the second units, in this order;
said third unit comprising a heat recovery unit of the indirect contact gas-gas type through which the air in which is being conditioned is forced to circulate for preheating thereof, the third unit being provided for this purpose with a hot inlet and a cold outlet for a recovery gas that is also forced to circulate through the heat recovery unit.

2. The system according to claim 1, wherein the heat recovery is a hexagonal cross-flow heat exchanger.

3. The system according to claim 1, wherein the first air conveying unit, the third air conveying unit and the second air conveying unit are configured to be coupled in succession and on the same mounting plane.

4. The system according to claim 3, wherein the space surrounding the heat recovery unit in the third unit is compartmentalised alternating around the heat recovery unit and in the mounting plane
a compartment in communication with an intake of air to be preheated of the heat recovery unit, into which compartment leads an inlet of air to be preheated from the third module connectable to a dehumidified air outlet of the first module when said first and third modules are mutually coupled;
a preheated air compartment in communication with a preheated air expulsion of the heat recovery unit, into which compartment leads a preheated air outlet of the third module connectable to a preheated air inlet of the second module when said second and third modules are mutually coupled;
a compartment in communication with a hot recovery gas intake of the heat recovery unit into which leads a hot inlet of the third module; and
a compartment in communication with a cold recovery gas expulsion of the heat recovery unit that leads into a cold outlet of the third unit.

5. The system according to claim 4, wherein the mounting plane is a vertical plane, the inlet of air to be preheated being at a level above the preheated air outlet; and the hot recovery gas inlet being at a level above the cold recovery gas outlet.

6. The system according to claim 5, wherein the compartment in communication with the cold recovery gas expulsion of the heat recovery unit houses an auxiliary condensate collector, located in a vertical projection of said cold recovery gas expulsion of the heat recovery unit.

7. The system according to claim 6, wherein the system comprises an evacuation box of the recovery gas configured to be coupled to the cold recovery gas outlet of the third unit and sized in accordance with the first unit serving as a support for said first unit.

8. The system (1′) according to claim 4, wherein the mounting plane is a horizontal plane and in that the system comprises an evacuation box of the recovery gas configured be coupled to the cold recovery gas outlet of the third unit and configured to then be arranged juxtaposed to the first unit.

9. The system according to claim 1, wherein the dehumidification means housed in the first unit comprise first filter means, a cooling coil and a condensate collector.

10. The system according to claim 1, wherein the heating means comprise a impelling fan, a steam coil and second filter means.

11. An installation comprising an air conditioning system according to claim 1 with a coating, spraying or drying device to which an operational air flow is supplied and a used air flow is returned, in which this operational air flow contains air conditioned by the system and in which the recovery gas used by the system contains used air.

12. The installation according to claim 11, wherein it comprises a bypass branch at the inlet of the device and in that the recovery gas used by the system comes from a mixture of the air used by the device and the air bypassed by the bypass branch.

13. The installation according to claim 11, wherein it is devoid of a silencing device of the air flow used by the device.
